(19) United States
(12) Patent Application Publication
(10) Pub. No.: US 2013/0173116 A1
(43) Pub. Date: Jul. 4, 2013

(54) AUTOMATIC TRANSITION CONTROL OF HITCH MODES

(71) Applicant: AGCO Corporation, Duluth, GA (US)

(72) Inventors: Alan D. Gustafson, Lakefield, MN (US); Trail Price, Jackson, MN (US)

(73) Assignee: AGCO CORPORATION, Duluth, GA (US)

(21) Appl. No.: 13/727,668

(22) Filed: Dec. 27, 2012

Related U.S. Application Data
(60) Provisional application No. 61/580,904, filed on Dec. 28, 2011.

(51) Int. Cl. A01B 69/00

(52) U.S. Cl. CPC A01B 69/004
USPC 701/41

(57) ABSTRACT

In one embodiment, a control method for a multi-mode steerable 3-point hitch coupled to a work machine, the hitch comprising a pivotal hitch frame and a hitch support structure affixed to a chassis of the work machine, the hitch frame coupled to first and second draft arms and the hitch support structure coupled to a pair of steering cylinders that are coupled to the hitch frame, the control method comprising: receiving a signal corresponding to one or more parameters; and responsive to the one or more parameters reaching or exceeding a respective threshold value, automatically causing the plural steering cylinders to switch between the non-articulated mode and the multi-mode, the multi-mode including articulation and draft sway motion of the hitch.

### CROSS REFERENCE TO RELATED APPLICATION

This application claims priority to copending U.S. provisional application entitled, “Automatic transition Control of Hitch Modes,” having Ser. No. 61/580,904, filed Dec. 28, 2011, which is entirely incorporated herein by reference.

### TECHNICAL FIELD

The present disclosure is generally related to 3-point hitches, and in particular, 3-point hitches for track-type tractors pulling agricultural implements.

### BACKGROUND

Conventional 3-point hitch design practice for wheel-type tractors is described in ASAE S217.12, “Three-Point Free-Link Attachment for Hitching Implements to Agricultural Wheel Tractors.” Although this design practice is long established for wheel-type tractors, it has historically caused steering performance problems for 2-track, tractor-type tractors, due to the unique steering method employed by these machines. A performance improvement has previously been accomplished by modifying the ASAE design practice to incorporate single-axis articulation (rotation), which, though successful in improving performance while under high draft load, has in some instances resulted in reduced implement tracking stability.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an example environment in which an embodiment of a multi-mode steerable 3-point hitch may be used.

FIG. 2 is a schematic diagram that illustrates a rear end elevation view of a track-based tractor equipped with an embodiment of a multi-mode steerable 3-point hitch.

FIG. 3 is a schematic diagram that illustrates a partial, left-rear elevation view of an embodiment of a multi-mode steerable 3-point hitch.

FIG. 4 is a schematic diagram that illustrates in partial bottom view a lower link portion of an embodiment of a multi-mode steerable 3-point hitch.

FIG. 5 is a schematic diagram that illustrates an abbreviated, plan view of a lower link portion of an embodiment of a multi-mode steerable 3-point hitch without draft arm sway or articulation.

FIG. 6 is a schematic diagram that illustrates an abbreviated, plan view of a lower link portion of an embodiment of a multi-mode steerable 3-point hitch in a first mode corresponding to only draft arm sway.

FIG. 7 is a schematic diagram that illustrates an abbreviated, plan view of a lower link portion of an embodiment of a multi-mode steerable 3-point hitch in a second mode corresponding to only hitch frame rotation.

FIG. 8 is a schematic diagram that illustrates an abbreviated, plan view of a lower link portion of an embodiment of a multi-mode steerable 3-point hitch in a third mode corresponding to the combination of hitch frame rotation and draft arm sway.

FIG. 9 is a block diagram that illustrates an embodiment of a control system for switching among multiple modes of an embodiment of a multi-mode steerable 3-point hitch.

FIG. 10 is a block diagram that illustrates an embodiment of an example controller for switching among multiple modes of an embodiment of a multi-mode steerable 3-point hitch.

FIG. 11 is a flow diagram that illustrates an embodiment of a method for operating among multiple modes of an embodiment of a multi-mode steerable 3-point hitch.

FIG. 12 is a flow diagram that illustrates an embodiment of a control method for switching among multiple modes of an embodiment of a multi-mode steerable 3-point hitch.

### DESCRIPTION OF EXAMPLE EMBODIMENTS

### Overview

In one embodiment, a control method for a multi-mode steerable 3-point hitch coupled to a work machine, the hitch comprising a pivotal hitch frame and a hitch support structure affixed to a chassis of the work machine, the hitch frame coupled to first and second draft arms and the hitch support structure coupled to a pair of steering cylinders that are coupled to the hitch frame, the control method comprising: receiving a signal corresponding to one or more parameters; and responsive to the one or more parameters reaching or exceeding a respective threshold value, automatically causing the plural steering cylinders to switch between the non-articulated mode and the multi-mode, the multi-mode including articulation and draft sway motion of the hitch.

### DETAILED DESCRIPTION

Certain embodiments of an invention comprising a multi-mode steerable 3-point hitch and associated control systems and methods are disclosed that integrate features of both multi-link and articulation methods. A multi-mode steerable 3-point hitch may improve steering capability under high draft loads for track-type agricultural tractors utilizing 3-point hitch-mounted implements. For instance, in one embodiment, the multi-mode steerable 3-point hitch uses a combination of multi-link and articulation (rotation) methods to optimize side-to-side motion control of these implements, using any one of three basic modes of operation. In some embodiments, a control system is implemented that enables switching between different modes of operation. For instance, the control system may configure the multi-mode steerable 3-point hitch for operation that permits draft arm sway only, and in another mode, operation that permits draft arm sway and articulated motion.

In contrast, as set forth previously, conventional 3-point hitches are limited to either single axis articulation methods or multi-link methods, which may be insufficient as to steering performance under high draft loads, among other circumstances. With certain embodiments of the control system, operation may switch from straight-row operation (e.g., permitting only draft arm sway) to multi-mode operation (e.g., permitting draft arm sway and articulated movement), enabling a tighter turn radius with ample control of the implement while engaged with the ground without delaying field operations to lift the hitch assembly.

Having summarized various features of certain embodiments of a multi-mode steerable 3-point hitch of the present disclosure as compared to conventional assemblies, reference will now be made in detail to the description of the disclosure as illustrated in the drawings. While the disclosure is described in connection with these drawings, there is no intent to limit it to the embodiment or embodiments disclosed herein. Further, although the description identifies or describes specifics of one or more embodiments, such specifics are not necessarily part of every embodiment, nor are all various stated advantages associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

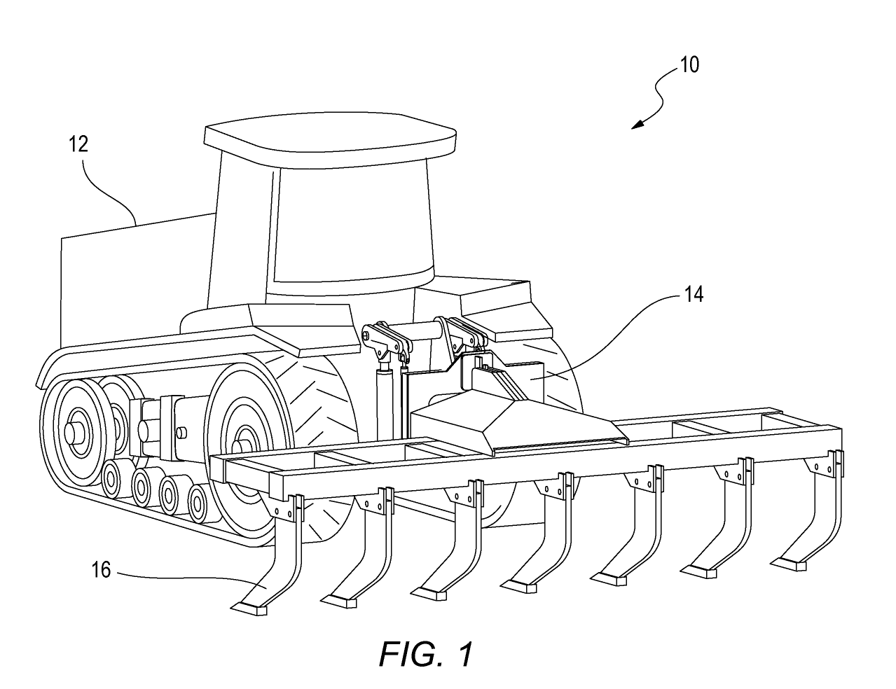

Referring now to FIG. 1, shown is an example environment 10 in which certain embodiments of a multi-mode steerable 3-point hitch may be employed. One having ordinary skill in the art should appreciate in the context of the present disclosure that the example environment 10 is merely illustrative, and that multi-mode steerable 3-point hitches as disclosed herein may be implemented in other environments. As seen in FIG. 1, a work machine (e.g., a 2-track tractor) 12 is shown with a multi-mode steerable 3-point hitch 14 coupled to the work machine 12 and to a coupled implement 16. The work machine 12 is seen traversing the ground via two endless tracks, such as in a farm setting, with the implement 16 towed from behind.

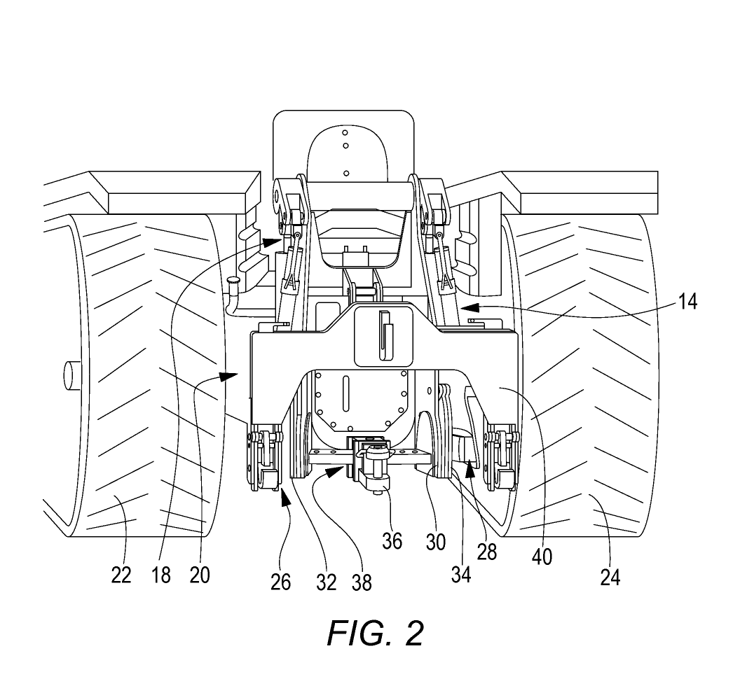

Referring to FIG. 2, shown is an example rear end elevation view of the work machine 12, which provides a further detail of the multi-mode steerable 3-point hitch 14. The multi-mode steerable 3-point hitch 14 comprises a top level assembly 18 in operable relationship to a bottom level assembly 20, the hitch 14 located at least partially between tracks 22 and 24 of the work machine 12. Many of the features and their operation as shown in FIG. 2 are well-known, and so particular emphasis is placed on the bottom level assembly 20. For instance, the bottom level assembly 20 of the multi-mode steerable 3-point hitch 14 comprises draft arms 26 and 28 separated from a pivotal or pivoting hitch frame 30 by respective (removable) guide blocks 32 and 34. Central (along a vertical axis), yet moveable, is a drawbar 36. The drawbar 36 is coupled to an implement, such as implement 16, and moves side-to-side via slot 38. Also shown is a coupler 40, which serves to raise and lower the coupled implement, such as implement 16.

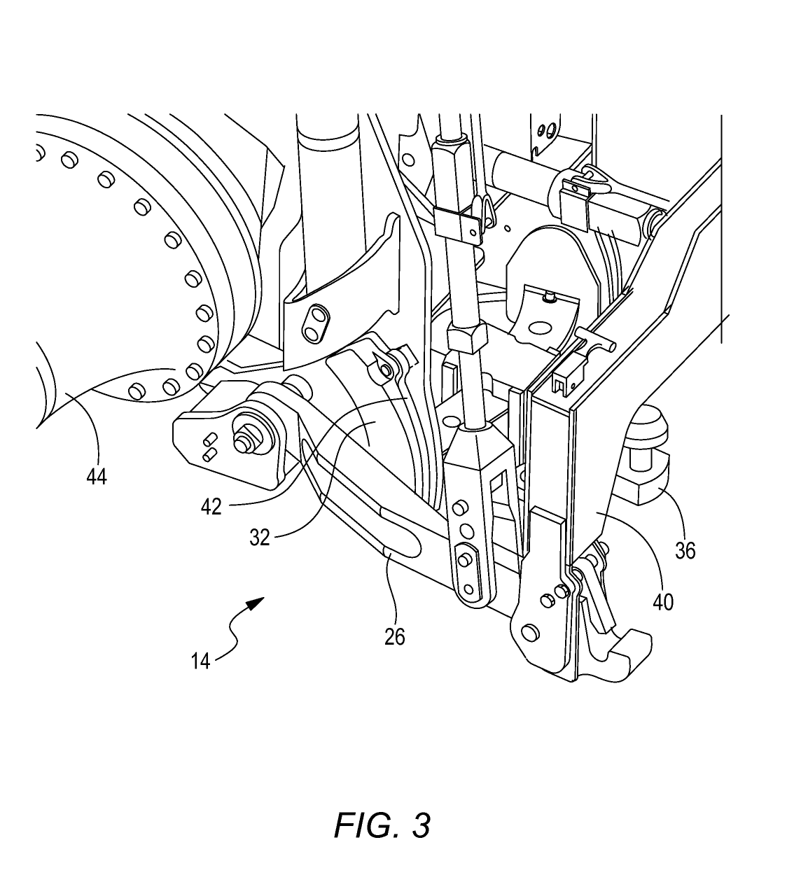

Having generally described certain features of the bottom level assembly 20 of the multi-mode steerable 3-point hitch 14, attention is directed to FIG. 3, which shows a schematic diagram in left rear elevation view of portions of the multi-mode steerable 3-point hitch 14. As shown, the multi-mode steerable 3-point hitch 14 comprises the drawbar 36, coupler 40, draft arm 26, and guide block 32. The guide block, such as guide block 32, may include removable spacers, such as spacer 42 that, in combination with the guide block 32, may push the draft arm 26 out further, resulting in zero or insignificantly perceptible draft arm sway. Also shown is a portion of the chassis 44 (e.g., axle) of the work machine 12.

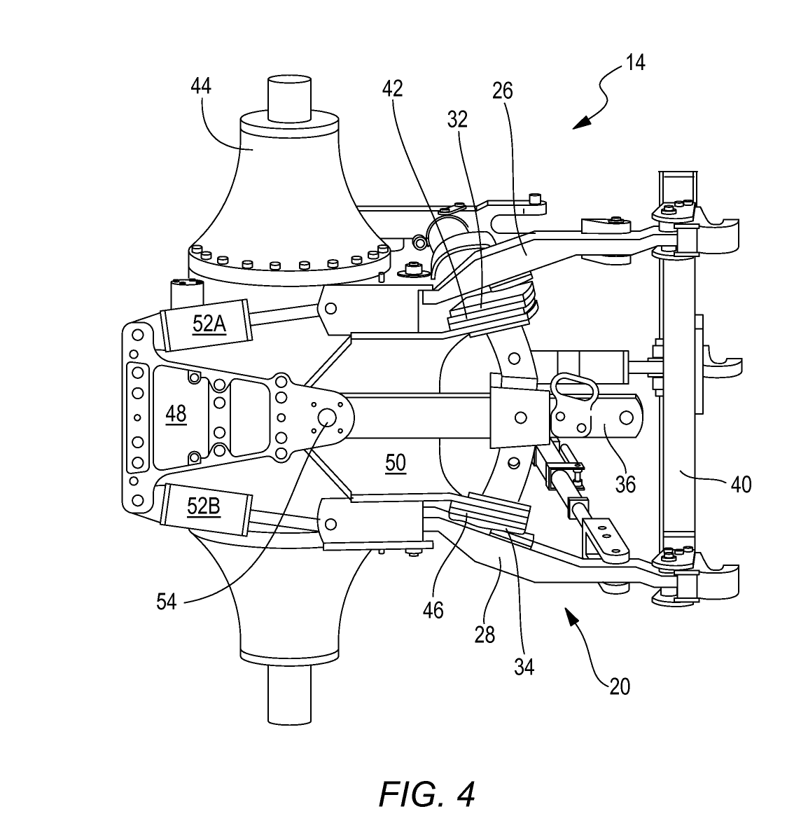

Referring now to FIG. 4, shown is a schematic diagram of the bottom level assembly 20 of the multi-mode steerable 3-point hitch 14, viewed from the bottom looking up in a slight perspective. As previously described, the multi-mode steerable 3-point hitch 14 comprises the coupler 40, the pairs of draft arms 26 and 28, the draw bar 36, the guide blocks 32 and 34 (which may include removable spacers 42 and 46), and the chassis 44. Further introduced in FIG. 4 is a generally triangular-shaped hitch support structure 48 affixed to the chassis 44, a pivotal hitch frame 50 (referred to previously as frame 30) coupled to the hitch support structure 50, and opposing steering cylinders (e.g., hydraulic) 52 (e.g., 52A, 52B) that are coupled to the hitch support structure 48 and movably extend between the hitch support structure 48 and the hitch frame 50 (e.g., the rod ends of the cylinders 52 are connected to the hitch frame 50). The hitch support structure 48 is coupled to the hitch frame 50 at a location corresponding to a pivotal axis point 54 (herein, also referred to as pivot point).

The hitch frame 50 pivots about a vertical axis (e.g., running into and out of the paper in FIG. 4) at the pivot point 54 based on the opposing actions of the steering cylinders 52A, 52B. For instance, extension of the steering cylinder 52A and hence contraction (e.g., retraction) of the steering cylinder 52B results in a pivot motion of the frame 50 (and draw bar 36) to the right (e.g., in the direction toward the bottom of the page in FIG. 4). Alternatively, retraction of the steering cylinder 52A and hence extension of the steering cylinder 52B results in a pivot motion of the frame 50 (and draw bar 36) to the left (e.g., in the direction toward the top of the page in FIG. 4). A steering cylinder control module (also referred to herein as a steering cylinder control module), not shown in this view, causes the steering cylinders 52 to unlock to allow the hydraulic fluid (e.g., oil) to flow freely between the steering cylinders) and hence allow this rotation or articulation) to enable turning of the implement. The steering cylinder control module also is configured to actuate the steering cylinders 52 to lock, and hence prevent articulation (e.g., no opposable movement or any independent movement of the steering cylinders 52). Articulation may be prevented where the work machine 10 and implement 12 are traveling along a row. In some embodiments, the steering cylinders 52 may be permitted to always be free-floating, and hence need not be controlled by the steering cylinder control module, or in some embodiments, locking and unlocking may be performed manually.

The draft arms 26 and 28 enable draft arm sway, based on the selected guide blocks 32 and 34 and their relationship relative to the hitch frame 50. For instance, the guide blocks 32 and 34 are each shown abutted against the hitch support structure (e.g., each in contact), indicating that an appropriate thickness of the spacers 42 and 46 are included (e.g., manually inserted) to ensure that draft arm sway is not permitted. In some embodiments, the spacers 42 and 46 may be removed, which permits movement of the draft arms 26 and 28 from adjacent the guide blocks 32 and 34 to a lateral movement corresponding to the structural limitations (e.g., the guide blocks 32 and 34) of the hitch frame 50.

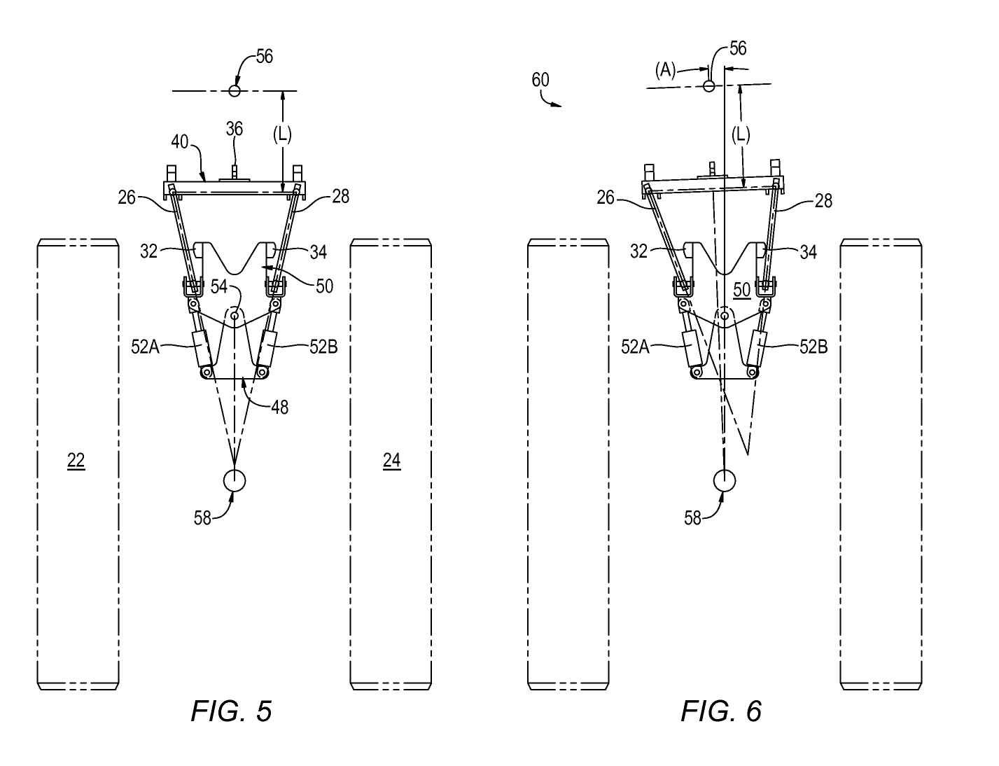

Having described essential features of the multi-mode steerable 3-point hitch 14, attention is directed to FIGS. 5-8, which illustrates several example switchable modes of operation. FIG. 5 introduces the multi-mode steerable 3-point hitch 14 in a general configuration to introduce what is being shown in these figures and those that follow, the understanding that certain features of the multi-mode steerable 3-point hitch 14 are omitted to avoid obscuring structure more relevant to the mode features. FIG. 5 (and FIGS. 6-8) are schematic diagrams in overhead plan view that depict the multi-mode steerable 3-point hitch 14 disposed at least in part between the tracks 22 and 24, and including the hitch support structure 48 coupled to the hitch frame 50 at pivot point 54, and comprising steering cylinders 52 (e.g., 52A and 52B) coupled to opposite sides of the hitch frame 50. Also depicted in FIG. 5 are the draft arms 26 and 28 extending outwardly from the hitch frame 50 and coupled to the coupler 40. The hitch frame 50 further depicts guide blocks 32 and 34 in FIG. 5 as adjacent to (and in direct contact with) draft arms 26 and 28, respectively. Introduced in FIG. 5 is an implement load center position 56 (herein load center) and an approximate center of work machine (e.g., tractor) rotation 58, for purposes of illustrating sway and rotation relative to the implement 14 and work machine 12. Shown also in part is the draw bar 36 aligning along an axis with the implement load center 56. The general configuration depicted in FIG. 5 is one example illustration of the relative arrangement of components of, and/or involved with, the multi-mode steerable 3-point hitch 14 in a forward, non-turning direction. In addition, the arrangement of components as shown may also depict be construed in some embodiments as a mode comprising an absence of both articulation and draft arm sway (e.g., such as through the manual addition of the spacers 42 and 46 to the guide blocks 32 and 34 to ensure direct contact is maintained between the draft arms 26 and 28 and the guide blocks 32 and 34 at all times).

Having described a general configuration in FIG. 5, attention is directed to FIG. 6, which shows one mode of operation (referred to also as mode 1 for brevity, and denoted with reference numeral 60) where operation of the multi-mode steerable 3-point hitch 14 is according to draft arm sway only. For instance, the draft arms 26, 28 are allowed to float laterally until either guide block 32 or 34 is contacted, such as shown with guide block 34 in contact with draft arm 28. The draft arm 26 is shown in a full sway position. Narrow blocks 32 and 34 permit full sway positions. The steering cylinder 52 (e.g., 52A and 52B) are placed in hydraulic lock to prevent the hitch frame 50 from rotating. This mode 60 (mode 1) may improve lateral stability of “non-directional” implements (e.g., as described in ASAE S217.12, Appendix A) by providing an increased horizontal convergence distance. For instance, the ability to turn an implement under load can be represented by the length of the moment arm between the center of the tractor 58 and the center of the implement load 56, as shown by dimension (A) in FIG. 6. An increase in this distance A provides greater ability to turn an implement under load. Due to limitations in the design of conventional 3-point hitches, the magnitude of dimension (A) is typically very limited. A mechanical provision for preventing all lateral sway is provided for applications where implement movement is undesirable. This provision is typically accomplished by relocating the guide blocks 32 and 34 to a wider position (e.g., through the use of the spacers 42 and 46 or otherwise). Note that reference herein to contacting the guide blocks (e.g., by draft arms 26 and 28) may refer to direct contact of the guide blocks as well as indirect contact with the guide block through a spacer.

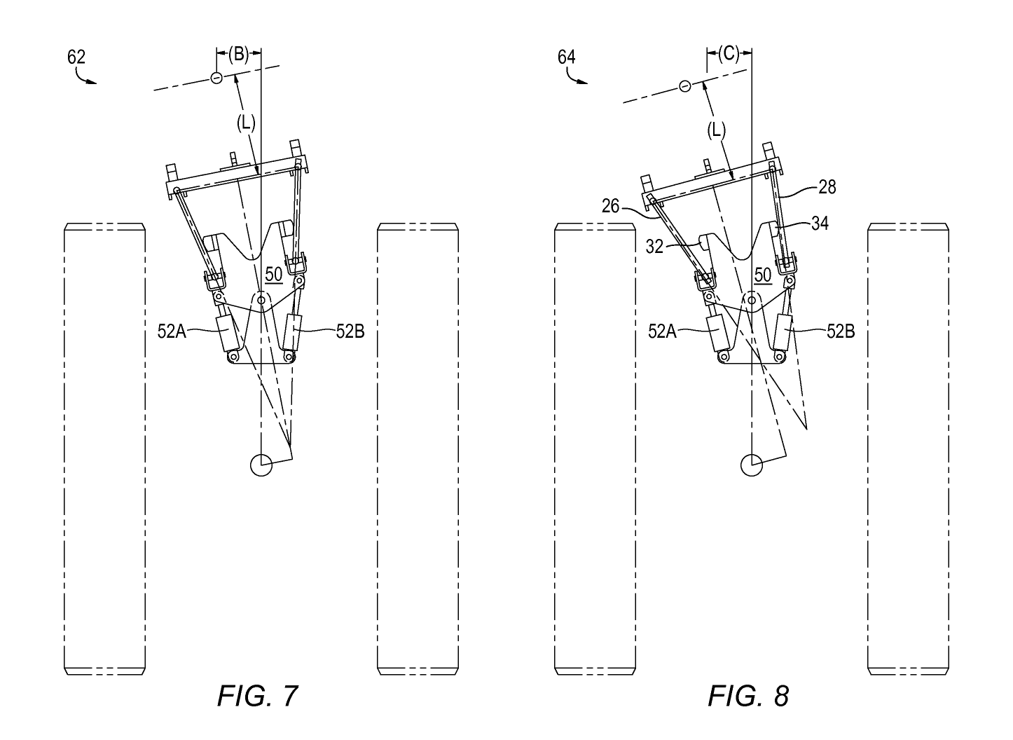

Referring now to FIG. 7, shown is an example operation of the multi-mode steerable 3-point hitch 14 according to another mode (e.g., referred to also as mode 2, and denoted in FIG. 7 with reference numeral 62). In mode 2 62, the operation of the multi-mode steerable 3-point hitch 14 is limited to articulation only (e.g., hitch frame rotation only). The wider guide block positions prevent draft arm sway. This mode 62 improves the work machine's ability to steer “directional” implements (e.g., as described in ASAE S217.12, Appendix A) by providing a decreased horizontal convergence distance. The steering cylinders 52 (e.g., 52A and 52B) are permitted to extend and contract (e.g., retract), allowing the hitch frame 50 to rotate. The implement turning force is greatly improved, as indicated in FIGS. 6-7 by comparing the relative length dimension (B) with dimension (A) from mode 1 60. Note that throughout FIGS. 5-8, the dimension (L) is held constant for purposes of facilitating the description. One possible drawback to this mode 62 may be a decrease in lateral stability of some types of non-directional implements.

Directing attention to FIG. 8, shown is yet another mode of operation of the multi-mode steerable 3-point hitch 14, referred to herein also as mode 3 64. In mode 3 64, the manner of operation of the multi-mode steerable 3-point hitch 14 consists of the combination of hitch frame rotation and draft arm sway. For instance, the draft arms 26 and 28 are allowed to float laterally until either guide block 32 or 34 is contacted. The narrow guide block positions permit full draft arm sway. In the embodiment depicted in FIG. 8, the guide block 34 is contacted (e.g., draft arm 28). In addition, the steering cylinders 52A and 52B are permitted to extend and contract, allowing the hitch frame 50 to rotate. The implement turning forces are significantly improved over the previously described modes 60 and 62, as indicated in FIG. 8 by the increased distance of dimension (C) compared to dimension (B) for mode 2 62 and dimension (A) for mode 1 60. The combined movement described in mode 3 operation is similar in effect to mode 2 operation, but with an additional amount of turning force improvement through draft arm sway. One possible drawback of this mode 60 is that the loss of lateral stability noted in mode 2 62 may still apply in some implementations. However, controlling the transition between draft arm sway only (mode 1 60) and the combined motion available in mode 3 64 enables the work machine 12 to utilize advantages of both modes.

Note that in one embodiment, one example of representative dimensions for A, B, and C dimensions include 175 millimeters (mm), 450 mm, and 650 mm, respectively. Other dimensions and/or ratio of differences from one mode to the next are contemplated to be within the scope of the disclosure.

In certain embodiments, the transition between non-articulation (e.g., draft arm sway only (mode 1 60)) and mode 3 64 may be accomplished according to one of at least two methods: free floating and automatic control. In free floating control, the draft arm sway and hitch frame rotation are free to move, and are limited only by the mechanical limits of the hitch structure.

In automatic control, this type of control acts on the steering cylinders 52, and can provide hydraulic locking, free motion, or commanded movement. Input parameters for automatic control may include one or a combination of the following: steering yaw rate, speed difference between tracks, individual drive axle torque, steering wheel rotational position, steering wheel rotation rate, hitch frame rotation angle, engine load, horizontal draft arm position, draft arm bending stress, global positioning system information, and/or guide block contact force.

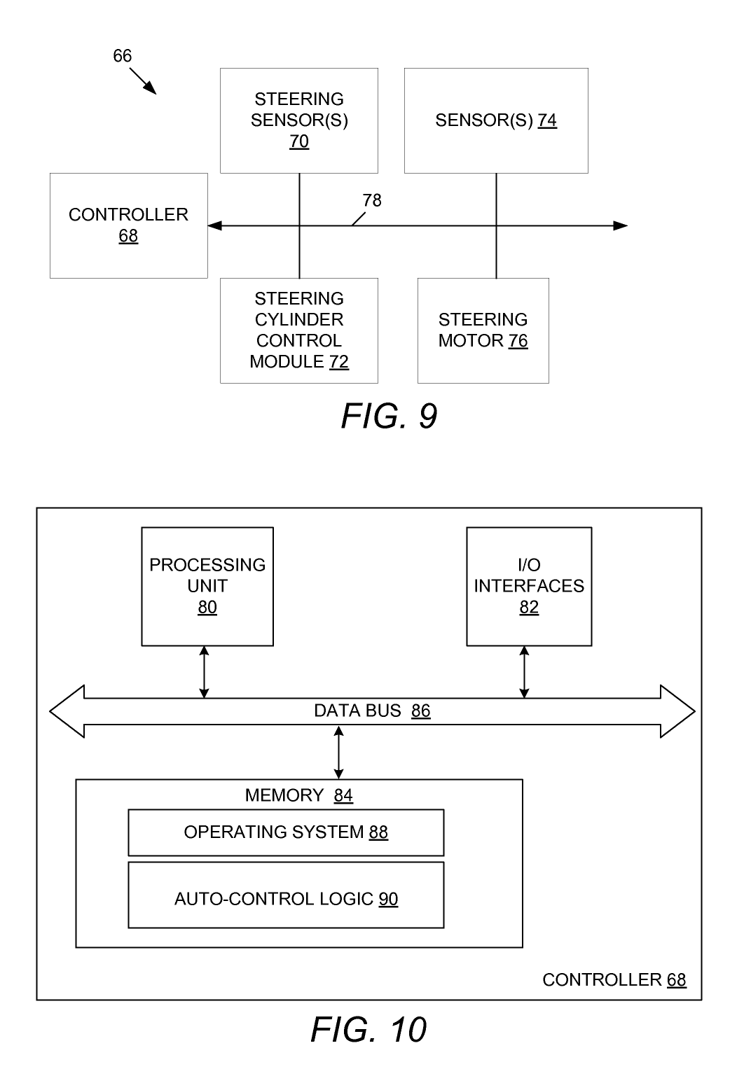

One example embodiment for a control system may be found in FIG. 9, which includes control system 66. In one embodiment, the control system 66 may reside on the work machine 12, and comprises a controller 68, steering sensor(s) 70, steering cylinder control module 72, sensor(s) 74, and steering motor 76, all coupled over a network 78 (e.g., CAN network, conductors, etc.). The controller 66 may include a computing device such as a programmable logic controller (PLC), semiconductor integrated circuit, central processing unit (CPU), among other types of computing devices, as explained further below. The steering sensor(s) 70 may be positioned proximally to the steering column to sense a rotation vector (e.g., direction, magnitude, etc.) of a steering mechanism (e.g., steering wheel, joy stick, etc.). The steering cylinder module 72 may include an electromagnetic device(s) or assemblies (e.g., solenoids, etc.) that enable the locking (e.g., for draft arm sway only mode of operation) and unlocking (e.g., for floating or generally articulated movement) of the steering cylinders 52. In some embodiments, the steering cylinder control module 72 may command directed movement based on a predefined movement of the steering cylinders 52. The sensor(s) 74 include one or more of a plurality of sensors that detect the aforementioned input parameters, including inertial sensors, GPS devices, piezoelectric devices, strain gauges, among others well-known to those having ordinary skill in the art. The steering motor 76 is well-known in the technology of differential steering, and provides a mechanism to control the spin rate of the tracks 22 and 24, and hence may be used to indicate the track rate speed of each track. For instance, the steering motor 76 comprises a shaft that, when not spinning, each track 22 and 24 is interpreted as moving at the same rate of speed. A spin of the shaft in one direction indicates that one of the tracks 22 or 24 is speeding up while the other is slowing down (and vice versa when the shaft spins in the other direction). The faster the speed of rotation of the shaft, the faster the rate of track speed.

In one embodiment, the controller 68 receives an input from the steering sensor 70 corresponding to a commanded turn of the work machine 12. Such a command may be based on an operator of the work machine 12 turning the steering wheel mechanism (e.g., steering wheel, joystick, etc.), or in some embodiments, via automated control (e.g., through the aid of a GPS device and geofence information). In other words, the controller 68 is programmed to interpret a given range of steering wheel rotation to be a zero curvature command (e.g., straight ahead), and rotations beyond the zero curvature range may be interpreted as commands to cause a turning of the work machine 12. The controller 68 receives (e.g., reads) the input from the steering sensor(s) 70 and commands the steering motor 76 to adjust the track speeds accordingly to enable the turn. The controller 68 further receives input (e.g., feedback, such as in closed-loop control, though not limited to closed-loop control) from the steering motor 76 and/or sensor(s) 74 to determine the actual speed of the tracks 22 and 24. The curvature determination is based in one embodiment in the width of the work machine 12 and the output of the steering motor 76. Based on the speed of the tracks 22 and 24 reaching or exceeding a predetermined threshold (e.g., a tight turn) as indicated by the steering motor 76 and/or sensors 74, the controller 68 signals the steering cylinder module 72 to actuate (e.g., unlock) the steering cylinders 52 to a float position, whereby the multi-mode steerable 3-point hitch 14 may operate in, for instance mode 2 62 or mode 3 64. The controller 68 continually monitors the steering motor 76 and/or sensors 74 to determine if a correction has been made to straighten the work machine 12, and once the straightening has been commanded, cause the steering cylinder module 72 to lock the steering cylinders 52. In one embodiment, the curvature threshold (e.g., indicating the requirement of a tight turn) may be equal to 1/10 (e.g., 10 meter radius), whereas 1/100 (e.g., 100 meter radius) may indicate to the controller 68 that movement is fairly straight. Other values for curvature may be used.

It should be appreciated that the above-described manner of control operation is merely one example control method among many others. For instance, the controller 68 may receive other input parameters, and base automated control (e.g., locking and/or unlocking) on threshold values for one or more of these parameters.

FIG. 10 further illustrates an example embodiment of the controller 68. One having ordinary skill in the art should appreciate in the context of the present disclosure that the example controller 68, depicted as a computer system, is merely illustrative, and that in some embodiments, may be configured as a semiconductor chip, programmable logic controller, or other processing device with the same or different functionality than illustrated in FIG. 10. In some embodiments, functionality illustrated for the controller 68 may be distributed among plural devices coupled to the controller 68 over the network 78 (FIG. 9). Certain well-known components of computer systems are omitted here to avoid obfuscating relevant features of the controller 68. In one embodiment, the controller 68 comprises one or more processing units 80, input/output (I/O) interface(s) 82, and a memory 84, all coupled to one or more data busses, such as data bus 86.

The memory 84 may include any one or a combination of volatile memory elements (e.g., random-access memory RAM, such as DRAM, and SRAM, etc.) and nonvolatile memory elements (e.g., ROM, hard drive, tape, CDROM, etc.). The memory 80 may store a native operating system, one or more native applications, emulation systems, or emulated applications for any of a variety of operating systems and/or emulated hardware platforms, emulated operating systems, etc. In the embodiment depicted in FIG. 10, the memory 84 comprises an operating system 88 and auto-control logic 90 (e.g., software and/or firmware). It should be appreciated that in some embodiments, additional or fewer software modules (e.g., combined functionality) may be employed in the memory 84 or additional memory. In some embodiments, a separate storage device may be coupled to the data bus 86, such as a persistent memory (e.g., optical, magnetic, and/or semiconductor memory and associated drives).

The auto-control logic 90 receives the one or more aforementioned parameters and determines when to transition between the various modes and then cause the transition (e.g., between mode 1 60 and mode 3 64). Execution of the software module 90 in memory 84 is implemented by the processing unit 80 under the auspices of the operating system 88. In some embodiments, the operating system 88 may be omitted and a more rudimentary manner of control implemented.

The processing unit 80 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 68.

The I/O interfaces 82 provide one or more interfaces to the network 78, as well as interfaces for access to computer readable mediums, such as memory drives, which includes an optical, magnetic, or semiconductor-based drive. In other words, the I/O interfaces 82 may comprise any number of interfaces for the input and output of signals (e.g., analog or digital data) for conveyance over the network 78 and other networks. The I/O interfaces 82 may further comprise I/O devices that the operator uses to enter commands, such as keyboards, or mouse, microphone, among others.

When certain embodiments of the controller 68 are implemented at least in part in logic configured as software/firmware, as depicted in FIG. 10, it should be noted that the logic can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program for use by or in connection with a computer-related system or method. The logic may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 68 are implemented at least in part in logic configured as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

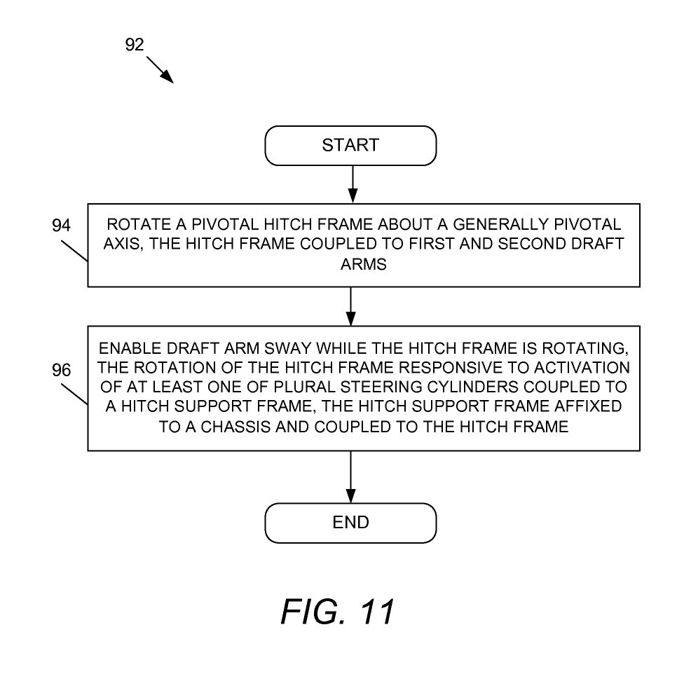

Having described certain embodiments of the multi-mode steerable 3-point hitch 14, it should be appreciated that one method embodiment, shown in FIG. 11 and denoted as method 92, comprises rotating a pivotal hitch frame about a generally pivotal axis, the hitch frame coupled to first and second draft arms (94); and enabling draft arm sway while the hitch frame is rotating, the rotation of the hitch frame responsive to activation of at least one of plural steering cylinders coupled to a hitch support frame, the hitch support frame affixed to a chassis and coupled to the hitch frame (96).

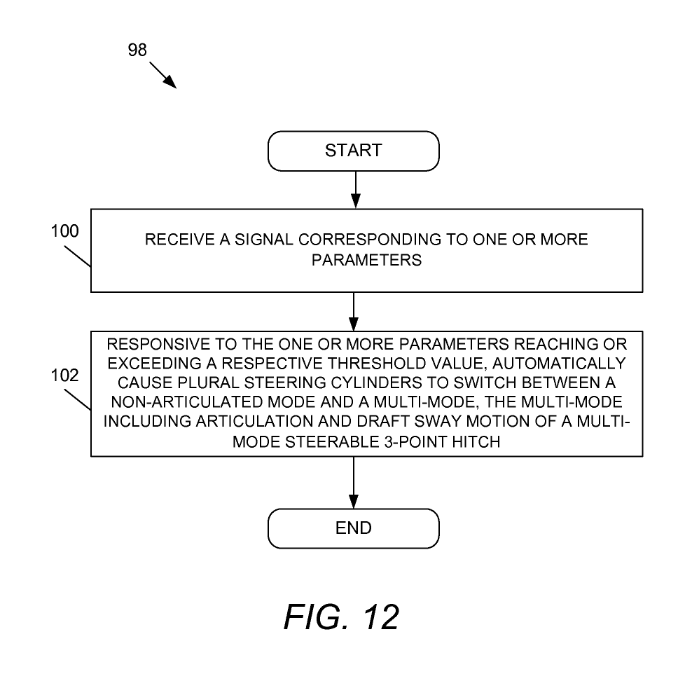

It should be appreciated that another method embodiment, shown in FIG. 12 and denoted as control method 98, comprises receiving a signal corresponding to one or more parameters (100); and responsive to the one or more parameters reaching or exceeding a respective threshold value, automatically causing plural steering cylinders to switch between a non-articulated mode and a multi-mode, the multi-mode including articulation and draft sway motion of a multi-mode steerable 3-point hitch (102).

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. For instance, it should be appreciated that the above-described methods are not limited to the example architectures described above, and that other variations of the embodiments described above and capable of performing the aforementioned methods of FIGS. 11 and 12 above are contemplated to be within the scope of the disclosure. Further, in some embodiments, operation of the hitch may be employed without electronic or electrical control. All such modifications and variations are intended to be included herein within the scope of this disclosure and protected by the following claims.

At least the following is claimed:

1. A control system for a multi-mode steerable 3-point hitch coupled to a work machine having plural tracks, the hitch comprising a pivotal hitch frame and a hitch support structure affixed to a chassis of the work machine, the hitch frame coupled to first and second draft arms and the hitch support structure coupled to a pair of steering cylinders that are coupled to the hitch frame, the control system comprising:
a cylinder control module, the cylinder control module configured to lock and unlock the steering cylinders to cause operation of the hitch in a non-articulated mode and a multi-mode, respectively, the multi-mode including combined articulated and draft sway movement; and
a controller coupled to the cylinder control module, the controller configured to:
receive a signal corresponding to one or more parameters; and
responsive to the one or more parameters reaching or exceeding a respective threshold value, signal the cylinder control module to cause the plural steering cylinders to switch between the non-articulated mode and the multi-mode.

2. The control system of claim 1, further comprising a steering motor with a shaft that rotates based on a speed differential between a first track and a second track of the work machine, the steering motor configured to provide the one or more parameters, wherein the one or more parameters comprises the speed differential, and the causing of the switch by the controller is further based on a width of the work machine.

3. The control system of claim 1, further comprising a sensor, wherein the sensor is configured to provide the one or more parameters, wherein the one or more parameters comprises one or a combination of steering yaw rate, hitch frame rotation angle, draft arm position, draft arm bending stress, and guide block bending force.

4. The control system of claim 3, wherein the sensor is an inertial sensor.

5. The control system of claim 1, further comprising a steering wheel sensor, wherein the steering wheel sensor is configured to provide the one or more parameters, wherein the one or more parameters comprises steering wheel rotational position and steering wheel rotational rate.

6. The control system of claim 1, further comprising a torque sensor, wherein the torque sensor is configured to provide the one or more parameters, wherein the one or more parameters comprises individual drive axle torque.

7. The control system of claim 1, further comprising an engine sensor, wherein the engine sensor is configured to provide the one or more parameters, wherein the one or more parameters comprises engine load.

8. The control system of claim 1, wherein the controller is further configured to signal to the cylinder control module to unlock the plural cylinders to cause multi-mode operation.

9. The control system of claim 8, wherein unlocking the plural cylinders corresponds to free flow of hydraulic fluid between the plural cylinders.

10. The control system of claim 1, wherein the controller is further configured to signal to the cylinder control module to lock the plural cylinders to cause non-articulated operation.

11. A control system for a multi-mode steerable 3-point hitch coupled to a work machine, the hitch comprising a pivotal hitch frame and a hitch support structure affixed to a chassis of the work machine, the hitch frame coupled to first and second draft arms and the hitch support structure coupled to a pair of steering cylinders that are coupled to the hitch frame, the control system comprising:
a cylinder control module, the cylinder control module configured to lock and unlock the steering cylinders to cause operation of the hitch in a non-articulated mode and a multi-mode, respectively, the multi-mode including combined articulated and draft sway movement; and
a controller coupled to the cylinder control module, the controller configured to:
determine a curvature corresponding to a turn command of the work machine; and
responsive to the curvature reaching or exceeding a defined threshold value, command the cylinder control module to switch between locking and unlocking the steering cylinders.

12. The control system of claim 11, wherein the controller is further configured to signal the cylinder control module to unlock the steering cylinders to enable articulated and draft sway movement of the hitch responsive to the curvature reaching or exceeding the defined threshold value.

13. The control system of claim 11, wherein the controller is further configured to signal the cylinder control module to lock the steering cylinders to restrict operation to draft sway movement of the hitch responsive to the curvature falling below the defined threshold value.

14. The control system of claim 11, wherein the determination of the curvature is based on a speed difference between tracks of the work machine.

15. The control system of claim 11, wherein the turn command is based on operator movement of a steering wheel mechanism.

16. The control system of claim 11, wherein the turn command is based on automated movement of a steering wheel mechanism.

17. The control system of claim 11, wherein the determination of the curvature is based on one or more parameters.

18. The control system of claim 17, wherein the one or more parameters include steering yaw rate, individual drive axle torque, steering wheel rotational position, hitch frame rotation angle, engine load, horizontal draft arm position, draft arm bending stress, and guide block contact force.

19. A control method for a multi-mode steerable 3-point hitch coupled to a work machine, the hitch comprising a pivotal hitch frame and a hitch support structure affixed to a chassis of the work machine, the hitch frame coupled to first and second draft arms and the hitch support structure coupled to a pair of steering cylinders that are coupled to the hitch frame, the control method comprising:
receiving a signal corresponding to one or more parameters; and
responsive to the one or more parameters reaching or exceeding a respective threshold value, automatically causing the plural steering cylinders to switch between the non-articulated mode and the multi-mode, the multi-mode including articulation and draft sway motion of the hitch.

20. The method of claim 19, wherein the one or more parameters include steering yaw rate, speed difference between tracks of the work machine, individual drive axle torque, steering wheel rotational position, hitch frame rotation angle, engine load, horizontal draft arm position, draft arm bending stress, global positioning system (GPS) information, and guide block contact force.
